(19) United States
(12) Patent Application Publication
(10) Pub. No.: US 2012/0128072 A1
(43) Pub. Date: May 24, 2012

(54) IMAGE CONVERTING APPARATUS, IMAGE REPRODUCING APPARATUS, AND IMAGE CONVERTING METHOD

(75) Inventors: Kenji KOBAYASHI, Osaka (JP); Masahiro WAKAMORI, Fukuoka (JP); Hiroyuki UWABO, Osaka (JP); Ryo KUBOTA, Fukuoka (JP); Takayuki SUZUKI, Osaka (JP)

(73) Assignee: Panasonic Corporation, Osaka (JP)

(21) Appl. No.: 13/296,614

(22) Filed: Nov. 15, 2011

(30) Foreign Application Priority Data
Nov. 16, 2010 (JP) 2010-255841

(51) Int. Cl. H04N 7/32; H04N 7/26

(52) U.S. Cl. 375/240.16; 375/E07.125; 375/E07.243

(57) ABSTRACT

An image reproducing apparatus that achieves a higher readiness, high-speed backward reproduction, and a minimum amount of data, at a time of executing a backward reproduction. An encoder-side intra predictor transcodes decode images of a front end and a back end of a GOP of an image stream. An encoder-side motion compensator transcodes a decode image other than that of the front end of the GOP of the image stream by setting a motion vector to 0 and using an immediately preceding reference image.

### CROSS REFERENCE TO RELATED APPLICATIONS

This application is entitled and claims the benefit of Japanese Patent Application No.2010-255841, filed on Nov. 16, 2010, the disclosure of which including the specifications, drawings and abstract are incorporated herein by reference in its entirety.

### TECHNICAL FIELD

The present invention relates to an image converting apparatus and an image reproducing apparatus for digitally compressed images, and in particular to a technology for use in special reproduction such as rewind reproduction.

### BACKGROUND ART

In an image reproducing apparatus that reproduces images compressed by a digital compression method such as MPEG2 or H.264, it is required to decode all pictures (I and P pictures) in a group of pictures (GOP) including the reproduced images in the case of backward reproduction (rewind reproduction), regardless of the order that the images (pictures) are reproduced. For this reason, the backward reproduction requires a large capacity of memory and thus it is generally known that the backward reproduction of digitally compressed images is relatively difficult compared with forward reproduction. Accordingly, there have been many technologies suggested so far in connection with that reproduction.

For example, there is a devised technology which reencodes (transcodes) the decoded images to decrease the number of structures (pictures) of a GOP of an original encoding image and decrease the memory capacity at the time of the backward reproduction (see Patent Literature 1).

### CITATION LIST

### Patent Literature

PTL 1: Japanese Patent Application Laid-Open No. 11-252507 (paragraphs [0041] to [0063] and FIG. 2)

### SUMMARY OF INVENTION

### Technical Problem

However, even though the number of structures (pictures) of the GOP of the original encoding image is decreased by re-encoding (transcoding) the decoded images, the decoding needs to be performed in an amount corresponding to the number of structures of the GOP (two times when there are two pictures). For this reason, at the time of the backward reproduction of multiple screens such as 16 CHs (CH stands for channel) which are assumed to be used for monitoring for example, readiness is not still obtained.

When the number of structures of the GOP is further decreased, that is, set to be a small number, one (I picture) to avoid the problem of the readiness, there occurs another problem such that the amount of data for the image increases, compared with the case of employing the P picture which uses a time correlation.

An object of the present invention is to provide an image converting apparatus, an image reproducing apparatus, and an image converting method that can realize a high readiness, a high speed backward reproduction, and a minimum amount of data, so as to be suitable for the backward reproduction of a multi-screen to be used for monitoring.

### Solution to Problem

In order to achieve the above object, one aspect of an image converting apparatus according to the present invention is an image conversion apparatus which transcodes a digitally compressed image stream. The image conversion apparatus includes an intra predictor configured to convert a decoded image of the image stream into an intra prediction image and a motion compensated predictor configured to convert a decoded image of the image stream into a motion compensated prediction image. The intra predictor transcodes first and final decoded images of a GOP (Group of Pictures) of the image stream and the motion compensated predictor transcodes all decoded images except the first decoded image of the GOP of the image stream by setting a motion vector to zero and referring to only an immediately preceding decoded image.

One aspect of an image reproducing apparatus of an image converting apparatus according to the present invention includes a decoder which generates a decode image of a digitally compressed image stream and the image converting apparatus transcodes the decode image. The image reproducing apparatus, when a forward reproduction is performed, transcoded images are sequentially decoded and reproduced by the decoder and the back end of the GOP is decoded and reproduced to produce a motion compensation prediction image, and, when a backward reproduction is performed, the back end of the GOP of the transcoded image is decoded and reproduced by the decode device using the intra prediction image.

One aspect of an image converting method according to the present invention is an image converting method that transcodes a digitally compressed image stream. The image converting method includes converting a decoded image of the image stream into an intra prediction image and converting a decoded image of the image stream into a motion compensated prediction image. Then, converting a decoded image of the image stream into an intra prediction image transcodes first and final decoded images of a GOP (Group of Pictures) of the image stream and converting a decoded image of the image stream into a motion compensated prediction image transcodes all decoded images except the first decoded image of the GOP of the image stream by setting a motion vector to zero and referring to only an immediately preceding decoded image.

Further, one aspect of an image reproducing apparatus according to the present invention includes an interface that receives a digitally compressed image stream from plural cameras through a network, a decode device that decodes the digitally compressed image stream and generates a decoded image, an image storage memory that stores the decoded image output by the decode device, a transcode device that receives the decoded image in the image storage memory and generates a transcoded stream, a storage medium that stores the digitally compressed image stream input by the interface and the transcoded stream transcoded by the transcode device, and an image combining section that combines image data stored in the image storage memory and outputs the image data to a monitoring monitor. In this case, the decode device includes an entropy decoding section that performs entropy decoding with respect to the digitally compressed image stream that is input by the interface and the storage medium, a decoder-side inverse quantizing section that performs inverse quantization with respect to entropy encoding released data that is input by the entropy decoding section, a decoder-side inverse DCT section that performs inverse DCT with respect to the data that is inversely quantized by the decoder-side inverse quantizing section, a decoder-side prediction method determining section that determines which prediction mode of intra prediction or motion compensation prediction is used, on the basis of the data where the inverse DCT is performed by the decoder-side inverse DCT section, a decoder-side intra predicting section that performs image decoding in a unit of macro block (MB) using the intra prediction, when intra prediction data is determined by the decoder-side prediction method determining section, a decoder-side motion compensating section that performs the image decoding in a unit of MB and calculates differential data, when motion compensation prediction data is determined by the decoder-side prediction method determining section, a code inverting section that determines whether inversion of positive and negative codes of the differential data calculated by the motion compensating section is performed, on the basis of a current decoding direction, and performs image decoding in a unit of MB with respect to the motion compensation data using a reference decoded image stored in a decoder-side reference image storage memory, a decoded image generating section that stores the decoded images decoded in a unit of MB in the decoder-side intra predicting section and the code inverting section and feeds back decoded peripheral MB information to the decoder-side intra predicting section, and a decoder-side reference image storage memory that stores the decoded images in the decoded image generating section, when the entire decoding in a unit of MB in one frame ends. The transcode device includes an encoder-side intra predicting section that generates an intra prediction image using the decoded image input from the image storage memory and a local decoded image obtained by the local decoded image generating section, an encoder-side motion compensating section that performs a motion compensation operation using the decoded image input from the image storage memory and the reference decoded image obtained by the encoder-side reference image storage memory, an encoder-side prediction method determining section that compares prediction images that are obtained by the encoder-side intra predicting section and the encoder-side motion compensating section and determines a prediction mode, a differential information generating section that generates differential information of an image, using a prediction method determined by the encoder-side prediction method determining section, a DCT section that performs a DC conversion with respect to the differential information obtained by the differential information generating section, a quantizing section that performs quantization with respect to data obtained by the DCT section, an entropy encoding section that performs entropy encoding with respect to the data obtained by the quantizing section and transmits the encode data to the transcoded stream combining section, an encoder-side inverse quantizing section that performs inverse quantization with respect to the data obtained by the quantizing section, an encoder-side inverse DCT section that executes an inverse DCT process with respect to the data output by the encoder-side inverse quantizing section, a local decoded image generating section that generates a local decoded image in a unit of MB, using the data output by the encoder-side inverse DCT section and the reference decoded image in the encoder-side reference image storage memory, and an encoder-side reference image storage memory that stores a reference local decoded image after the image data in a unit of MB decoded by the local decoded image generating section has been arranged by one frame.

By this structure, even when the backward reproduction is performed by performing the transcoding with respect to the digitally compressed moving image and storing the transcoded data in the storage medium, a data structure where backward decoding can be performed without decoding all of reference pictures in a forward direction can be provided, and high-speed backward decoding can be performed without affecting a forward decode operation.

### Advantageous Effects of Invention

According to the present invention, when the backward reproduction is performed at the certain time by performing transcoding (re-encoding) where the motion vector is set as 0 with respect to the digitally compressed moving image, desired backward reproduction can be performed by setting only one immediately previous image as a reference image and performing only one decoding using the corresponding image, without performing decoding corresponding to the number of structure images of the GOP in the related art.

Thereby, in the multi-screen reproduction such as 16 CHs which is assumed to be used for monitoring, even though the reproduction direction is switched into either the forward direction or the backward direction at the certain time, reproduction of a desired direction can be realized by only one decoding.

### BRIEF DESCRIPTION OF DRAWINGS

FIG. 1 is a block diagram showing a structure of an image reproducing apparatus in Embodiment 1 of the present invention;

FIG. 2 is a diagram showing an image stream in each block of the image reproducing apparatus;

FIG. 3 is a flowchart showing an operation of a decode device;

FIG. 4 is a flowchart showing an operation of a transcode device (operation of a portion other than a back end of a GOP);

FIG. 5 is a flowchart showing an operation of the transcode device (operation of the back end of a GOP); and

FIG. 6 is a diagram showing an example of a transcoded stream.

### DESCRIPTION OF EMBODIMENTS

Hereinafter, an embodiment of the present invention will be described in detail with reference to the accompanying drawings.

### [1] Entire Structure

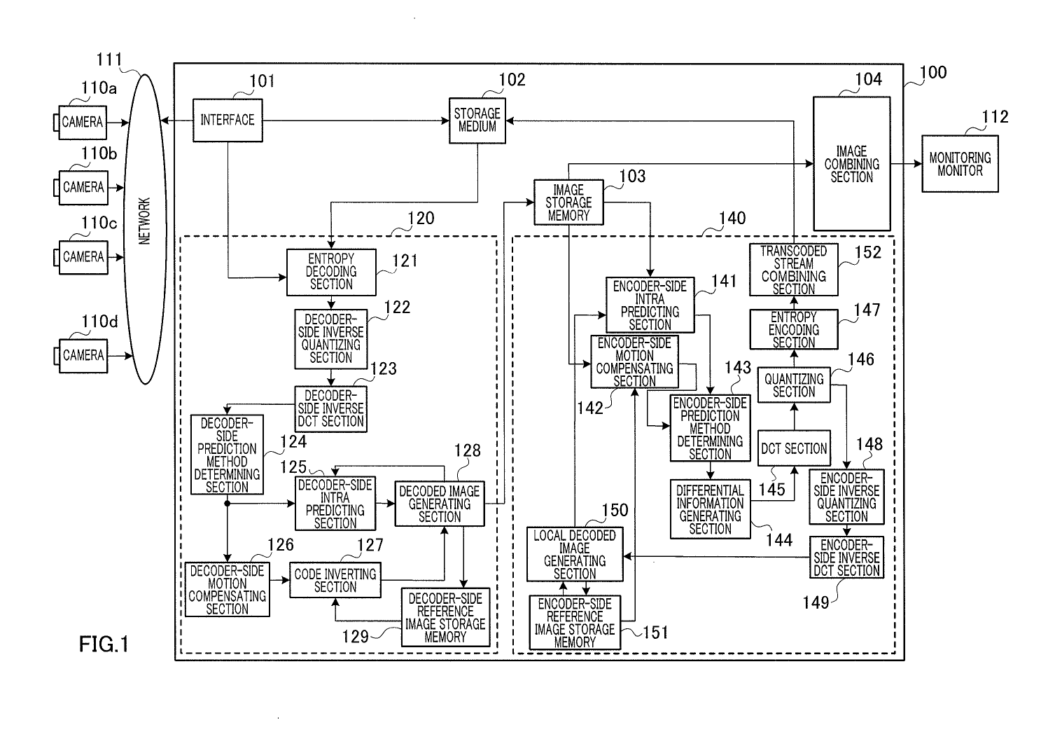

FIG. 1 is a block diagram showing a structure of an image reproducing apparatus according to an embodiment of the present invention. Image reproducing apparatus 100 performs special reproduction such as backward reproduction.

In the drawing, image reproducing apparatus 100 mostly has interface 101, decode device 120, image storage memory 103, transcode device 140, storage medium 102, and image combining section 104.

Interface 101 receives a digitally compressed image stream from plural cameras 110a to 110d through network 111. Decode device 120 decodes the image stream and generates a decoded image. Image storage memory 103 stores the decoded image output by decode device 120. Transcode device 140 receives the decoded image that is stored in image storage memory 103 and generates a transcoded stream. Storage medium 102 is a removable storage medium that stores the image stream input by interface 101 and the transcoded stream transcoded by transcode device 140. Image combining section 104 combines the image data of the plural cameras stored in image storage memory 103 and outputs the image data to monitoring monitor 112.

Decode device 120 includes entropy decoding section 121, decoder-side inverse quantizing section 122, decoder-side inverse DCT section 123, decoder-side prediction method determining section 124, decoder-side intra predicting section 125, decoder-side motion compensating section 126, code inverting section 127, decoded image generating section 128, and decoder-side reference image storage memory 129.

Entropy decoding section 121 performs entropy decoding with respect to the digitally compressed image stream that is input by interface 101 and storage medium 102. Decoder-side inverse quantizing section 122 performs inverse quantization with respect to entropy encoding released data that is input by entropy decoding section 121. Decoder-side inverse DCT section 123 performs inverse DCT with respect to the data that is inversely quantized by decoder-side inverse quantizing section 122. Decoder-side prediction method determining section 124 determines which prediction mode of intra prediction or motion compensation is used, on the basis of the data where the inverse DCT is performed by decoder-side inverse DCT section 123. When intra prediction data is determined by decoder-side prediction method determining section 124, decoder-side intra predicting section 125 performs image decoding in a unit of macro block (MB) using the intra prediction. When motion compensation data is determined by decoder-side prediction method determining section 124, decoder-side motion compensating section 126 performs the image decoding in a unit of MB with respect to the motion compensation data and calculates differential data. Code inverting section 127 determines whether inversion of positive and negative codes of the differential data calculated by motion compensating section 126 is performed, from a current decoding direction, and performs decoding in a unit of MB with respect to the motion compensation data using decoded image information stored in decoder-side reference image storage memory 129. Decoded image generating section 128 stores the decoded images that are decoded in a unit of MB in decoder-side intra predicting section 125 and code inverting section 127 and feeds back decoded peripheral MB information to decoder-side intra predicting section 125. Decoder-side reference image storage memory 129 stores the decoded images in decoded image generating section 128, when the entire image decoding in a unit of MB in one frame ends.

Transdecode device 140 includes encoder-side intra predicting section 141, encoder-side motion compensating section 142, encoder-side prediction method determining section 143, differential information generating section 144, DCT section 145, quantizing section 146, entropy encoding section 147, encoder-side inverse quantizing section 148, encoder-side inverse DCT section 149, local decoded image generating section 150, and encoder-side reference image storage memory 151.

Encoder-side intra predicting section 141 generates an intra prediction image using the decoded image input from image storage memory 103 and a local decoded image obtained by local decoded image generating section 150. Encoder-side motion compensating section 142 performs a motion compensation operation using the decoded image of image storage memory 103 and the reference local decoded image obtained by encoder-side reference image storage memory 151. Encoder-side prediction method determining section 143 compares prediction images that are obtained by encoder-side intra predicting section 141 and encoder-side motion compensating section 142 and determines the prediction mode. Differential information generating section 144 generates differential information of an image, using a prediction method determined by encoder-side prediction method determining section 143. DCT section 145 performs a DC conversion with respect to the differential information that is obtained by differential information generating section 144. Quantizing section 146 performs quantization with respect to data that is obtained by encoder-side DCT section 145. Entropy encoding section 147 performs entropy encoding with respect to the data obtained by quantizing section 146 and transmits the encode data to transcoded stream combining section 152. Encoder-side inverse quantizing section 148 performs inverse quantization with respect to the data that is obtained by quantizing section 146. Encoder-side inverse DCT section 149 executes an inverse DCT process with respect to the data that is output by encoder-side inverse quantizing section 148. Local decoded image generating section 150 generates a local decoded image in a unit of MB, using the data output by encoder-side inverse DCT section 149 and the reference decoded image in encoder-side reference image storage memory 151. Encoder-side reference image storage memory 151 stores a reference local decoded image after the image data in a unit of MB decoded by local decoded image generating section 150 has been arranged by one frame.

### [2] Operation

The operation of image reproducing apparatus 100 that has the above-described structure will be described using drawings.

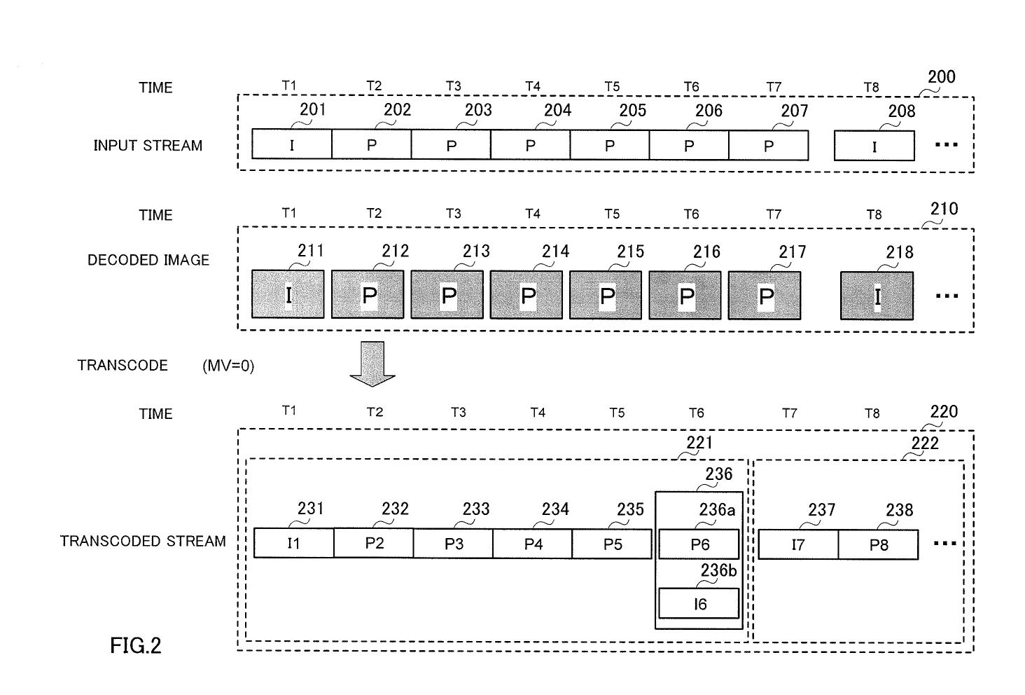

FIG. 2 is a diagram showing an image stream in each block of image reproducing apparatus 100. For example, FIG. 2 shows digitally compressed input stream 200 that is output by camera 110a, decoded image group 210 that is obtained by decoding the input image stream by decode device 120 (decoded image reproducing section 128), and transcoded stream 220 that is obtained by re-encoding decoded image group 210 by transcode device 140 (output from transcoded stream combining section 152).

In input stream 200, I denotes an image of an I picture and P denotes an image of a P picture. In the drawing, the image streams are arranged in frame order, in encode order by the cameras from the left side. In the normal GOP, a B picture is also included. However, the B picture is not generally used for the purpose of monitoring. In this case, an image stream that does not use the B picture is used. In the GOP that is configured using the I picture and the P picture, the encode order follows display order on the monitor. For the purpose of accumulation, the image stream that is output by camera 110a is transmitted to storage medium 102 through interface 101 and is stored. The image stream is also transmitted to decode device 120.

Next, generation of the decoded image group by decode device 120 and generation of the transcoded stream by transcode device 140 will be described.

(1) With Respect to the Generation of the Decoded Image Group

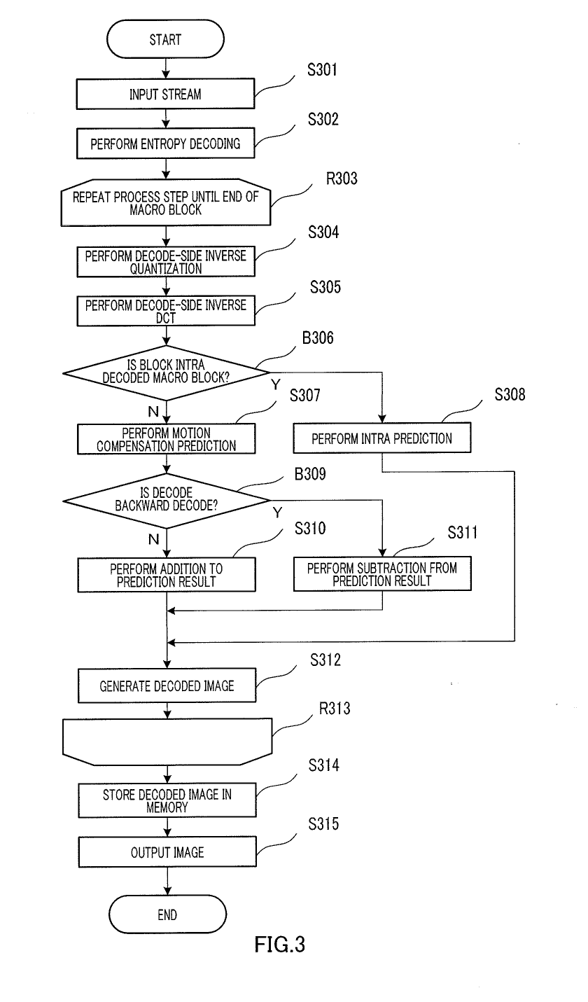

FIG. 3 is a flowchart showing an operation flow of decode device 120. In this case, a course of decoding images from image 201 of the time T1 to image 206 of the time T6 and generating the decoded image group from decoded image 211 to decoded image 216 will be described using the flowchart.

<Decode of Image 201 of the I Picture>

When decode device 120 receives the image 201 (I picture) of the image stream of the time T1 from storage medium 102 (S301), decode device 120 performs entropy decoding with respect to image 201 by entropy decoding section 121 (S302). A process step from the following S304 to S312 is repeated until a decode process of all macro blocks (MB) of image 201 ends (R303).

Next, decode device 120 executes a quantization process with respect to the entropy decoded data by decoder-side inverse quantizing section 122 (S304) and executes an inverse DCT process with respect to the inversely quantized data by the decoder-side inverse DCT section 123 to generate differential information of the image data in a unit of MB (S305).

Decode device 120 analyzes image information in decoder-side prediction method determining section 124 using the generated differential information and determines whether motion compensation is used in a unit of MB (B306). That is, decode device 120 determines whether the corresponding block is an intra encoded macro block. When the motion compensation is used, the process proceeds to S307 and when the motion vector is not used and the intra prediction is used, the process proceeds to S308. In this case, since image 201 is the I picture, the process proceeds to S308 in all MBs. In addition, in decoder-side intra predicting section 125, the intra prediction is performed using the already decoded MB information fed back from the decoded image generating section 128 as peripheral information and decoding performed (S308).

The decoded image is temporarily stored in decoded image generating section 128 until the decoding is completed with respect to all MBs in the image. The image that is temporarily stored in decoded image generating section 128 is used as peripheral information of the MBs to be decoded, in the process of S308 as described above (S312). After the process step from S304 to S312 ends with respect to all MBs of the image and decoded image 211 is generated, a loop process is skipped (R313). Finally, decoded image 211 that is generated by decoded image generating section 128 is stored in the decoder-side reference image storage memory 129 (S314) and is transmitted to image storage memory 103 (S315).

<Decode of Image 202 of the P Picture>

Next, a course of generating the decoded image of image 202 (P picture) will be described using the flowchart.

When decode device 120 receives image 202 (P picture) of the image stream of the time T2 from storage medium 102 (S301), decode device 120 performs entropy decoding with respect to image 202 by entropy decoding section 121 (S302). A process step from the following S304 to S312 is repeated until a decode process of all macro blocks (MB) of image 202 ends (R303).

Next, an inverse quantization process is executed with respect to the entropy decoded data in a unit of MB by decoder-side inverse quantizing section 122 (S304) and executes an inverse DCT process with respect to the inversely quantized data by decoder-side inverse DCT section 123 to generate differential information of the image data in a unit of MB (S305).

Analysis is performed on image information in decoder-side prediction method determining section 124 using the generated differential information and determines whether motion compensation is used in a unit of MB (B306). That is, a determination is made on whether the corresponding block is an intra encoded macro block. When the motion compensation is used, the process proceeds to S307 and when the motion compensation is not used and the intra prediction is used, the process proceeds to S308. In this case, since image 202 is the P picture, the process proceeds to either S307 or S308 in a unit of MB. In addition, in decoder-side motion compensating section 126, the motion compensation data is processed in a unit of MB and differential information of the image is acquired (S307). In addition, in decoder-side intra predicting section 125, the intra prediction is performed using the already decoded MB information fed back from decoded image generating section 128 as the peripheral information and the decoding is performed (S308).

In this case, different from the case of the I picture, in the case of the P picture, a current decode direction is determined in the code inverting section 127 (B309). The decode direction is a forward direction when the decode order follows time order and is a backward direction when the decode order follows inverse order of the time order. When the forward decoding is performed, the process proceeds to S310. When the backward decoding is performed, the process proceeds to S311. In this case, after decoding image 201 (I picture) of the image stream of the time T1, image 202 (P picture) of the image stream of the time T2 is decoded. Therefore, the forward decoding is performed and the process proceeds to S310. Since the forward decoding is performed, the differential information that is obtained by decode-side motion compensating section 126 is used in code inverting section 127, the motion compensation is performed using the decoded image stored in decoder-side reference image storage memory 129 as the reference image, and the decoding is performed (S310).

The decoded image is temporarily stored in decoded image generating section 128 until the decoding is completed on all MBs of the image. The image that is temporarily stored in decoded image generating section 128 is used as peripheral information of the MBs to be decoded, in the process of S308 as described above (S312). After the process step from S304 to S312 ends with respect to all MBs of the image and decoded image 212 is generated, a loop process is skipped (R313). Finally, decoded image 212 that is generated by decoded image generating section 128 is stored in decoder-side reference image storage memory 129 (S314) and is transmitted to image storage memory 103 (S315).

The course of decoding image 202 (P picture) of the image stream of the time T2 and generating decoded image 212 is described above. However, the same process is executed with respect to following P picture images 203, 204, 205, and 206 and decoded images 213, 214, 215, and 216 are generated. The generated decoded images are temporarily stored in image storage memory 103 and are transmitted to transcode device 140 of a next step.

(2) With Respect to the Generation of the Transcoded Stream

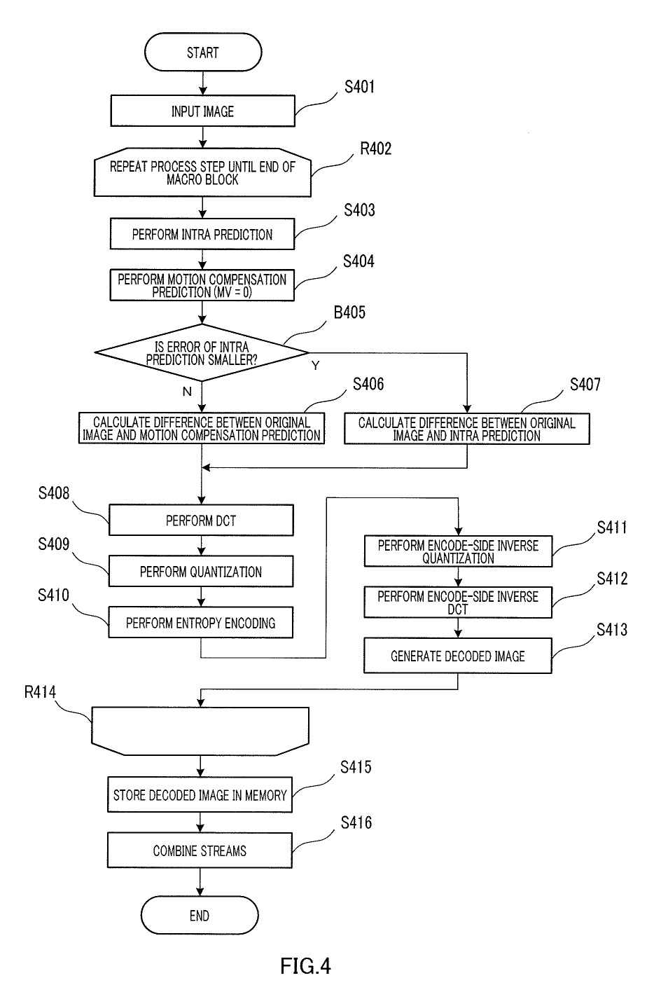

The generation of transcoded stream 220 will be described. FIG. 4 is a flowchart showing an operation of transcode device 140 (a portion other than the back end of the GOP). In this case, a course of receiving images from image 211 of the decoded image group of the time T1 to image 216 of the decoded image group of the time T6 and generating transcoded stream 221 by re-encoding where the number of images of the GOP is 6 will be described using the flowchart. The process of transcoding is mostly divided into three processes of (i) a transcode of an I picture where only the intra prediction is used, (ii) a transcode of a P picture where only the motion compensation is used, and (iii) a transcode of the back end of the GOP where both the intra prediction and the motion compensation are used. Hereinafter, each case will be described.

<(i) Generation of the Transcoded Image Using Only the Intra Prediction>

Transcode device 140 acquires decoded image 211 of the time T1 from image storage memory 103 (S401). A process step from the following S403 to S413 is repeated until a process of all macro blocks (MB) of image 211 ends (R402).

Next, in encoder-side intra predicting section 141, peripheral information is acquired from outputs of both decoded image 211 and local decoded image generating section 150 and an intra prediction image is generated for each MB (S403). Since transcoded image 231 of the generated transcoded stream of the time T1 is the I picture, a process is not executed in encoder-side motion compensating section 142 (S404).

Next, in encoder-side prediction method determining section 143, the generation result of the prediction image in each step of S403 and S404 and decoded image 211 input by the image storage memory 103 are compared and each prediction error is calculated (B405). In addition, the calculated prediction errors are compared with each other, and the process proceeds to S406 when the error of the prediction by the motion compensation is smaller than the error by the intra prediction and proceeds to S407 when the error of the intra prediction is smaller than the prediction error by the motion compensation. In this case, since transcoded image 231 is the I picture, the process proceeds to S407 in all of the macro blocks. In addition, in differential information generating section 144, calculation of the differential information between decoded image 211 input by image storage memory 103 and the intra prediction image is performed on the basis of the determination result of B405 (S407), and in DCT section 145, a DCT operation is performed with respect to the differential information (S408).

Next, quantizing section 146 performs an quantization operation with respect to the data output by DCT section 145 (S409) and entropy encoding section 147 performs entropy encoding with respect to the data output by quantizing section 146 (S410), and the encoding result is temporarily stored as data of 1 MB of transcoded image 231 in a memory (not shown in the drawings) of transcoded stream combining section 152. The data that is output by quantizing section 146 is input to entropy encoding section 147 and the inverse quantization process is executed in encoder-side inverse quantizing section 148 (S411). Encoder-side inverse DCT section 149 performs an inverse DCT operation with respect to the data output by encoder-side inverse quantizing section 148 (S412) and local decoded image generating section 150 collects the decoded data of a unit of MB as one image data (S413). Since the image data is used as the peripheral information in the intra prediction (S403), the image data is output to encoder-side intra predicting section 141.

When the process step of S403 to S413 ends with respect to all MBs of the image, the loop process is skipped (R414). After the process step ends with respect to all MBs of the image, one local decoded image is finished in local decoded image generating section 150 and the local decoded image is stored as the reference image data used at the time of next transcoding in encoder-side reference image storage memory 151 (S415). Finally, the transcoded image for each MB that is stored in transcoded stream combining section 152 is collected as one transcoded image and transcoded image 231 (I picture) of the transcoded stream is generated (S416). Generated transcoded image 231 is stored in storage medium 102.

<(ii) Generation of the Transcoded Images Using Only the Motion Compensation Prediction>

Next, the transcode of the P picture using only the motion compensation will be described. Transcode device 140 acquires decoded image 212 of the time T2 from image storage memory 103 (S401). A process step from the following S403 to S413 is repeated until a process of all macro blocks (MB) of decoded image 212 ends (S402).

Next, since generated transcoded image 232 of the transcoded stream of the time T3 is the P picture using only the motion compensation prediction, a process is not executed in encoder-side intra predicting section 141 (S403). In encoder-side motion compensating section 142, decoded image 212 of the time T2 is acquired from image storage memory 103, the reference image is acquired from encoder-side reference image storage memory 151, and the prediction image based on the motion compensation is generated for each MB (S404). However, a method of calculating the motion compensation in this embodiment sets a motion vector (MV) as zero and uses only an immediately previous image as time.

Next, in encoder-side prediction method determining section 143, the generation result of the prediction image in each step of S403 and S404 and decoded image 212 input by image storage memory 103 are compared and each prediction error is calculated (B405). In addition, the calculated prediction errors are compared with each other, and the process proceeds to S406 when the error of the prediction by the motion compensation is smaller than the error by the intra prediction and proceeds to S407 when the error of the intra prediction is smaller than the prediction error by the motion compensation. In this case, since transcoded image 232 is the P picture using only the motion compensation prediction, the process proceeds to S406 in all of the macro blocks. In addition, in differential information generating section 144, calculation of the differential information between decoded image 212 input by image storage memory 103 and the prediction result by the motion compensation where the motion vector (MV) is set as zero and only the immediately previous reference image (decoded image 211) of T1 is used as the time is performed on the basis of the determination result of B405 (S406).

Next, DCT section 145 performs a DCT operation with respect to the differential information (S408), quantizing section 146 performs a quantization operation with respect to the data output by DCT section 145 (S409), and entropy encoding section 147 performs the entropy encoding with respect to the data output by quantizing section 146 (S410) and temporarily stores the encoding result as data of 1 MB of transcoded image 232 in a storage memory (not shown in the drawings) of transcoded stream combining section 152. In addition, the data that is output by quantizing section 146 is input to entropy encoding section 147 and the inverse quantization process is executed in encoder-side inverse quantizing section 148 (S411). Encoder-side inverse DCT section 149 performs the inverse DCT operation with respect to the data output by encoder-side inverse quantizing section 148 (S412) and local decoded image generating section 150 collects the decoded data of a unit of MB as one image data (S413).

When the process step of S403 to S413 ends with respect to all MBs of the image, the loop process is skipped (R414). When the process step ends with respect to all MBs of the image, one local decoded image is finished in local decoded image generating section 150 and the local decoded image is stored as the reference image used at the time of next transcoding in encoder-side reference image storage memory 151 (S415). Finally, the transcoded image for each MB that is stored in transcoded stream combining section 152 is collected as one transcoded image and transcoded image 232 (P picture) is generated (S416). Generated transcoded image 232 is stored in storage medium 102.

The course of transcoding decoded image 212 (P picture) of the decoded image group of the time T2 and generating transcoded image 232 is described above. However, the process contents are applicable to generation of transcoded images 233, 234, and 235 of the P picture of the times T3, T4 and T5.

<(iii) Generation of the Transcoded Image of the Back End of the GOP>

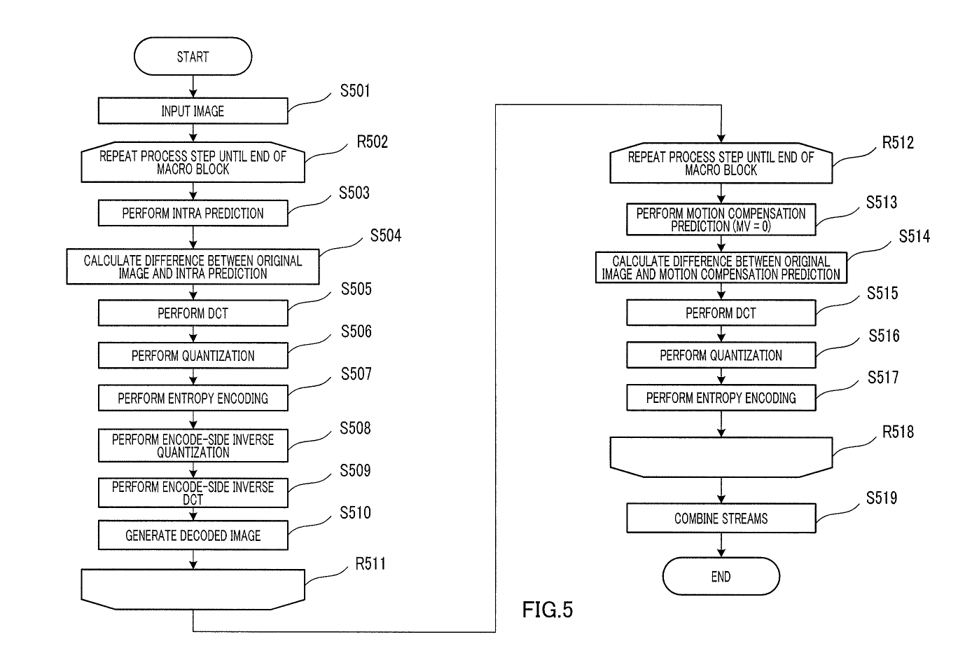

Next, the transcode of the back end of the GOP using both the intra prediction and the motion compensation will be described. FIG. 5 is a flowchart showing an operation of transcode device 140 (back end of the GOP).

Transcode device 140 acquires decoded image 216 of the time T6 from image storage memory 103 (S501). A process step from the following S503 to S510 is repeated until a decode process of all macro blocks (MB) of decoded image 216 ends and transcoded image 236b (I picture) of the transcoded stream is generated.

First, encoder-side intra predicting section 141 acquires the peripheral information that is the information already encoded by local decoded image generating section 150 and generates the intra prediction image for each MB (S503). Differential information generating section 144 calculates the differential information using decoded image 216 input by image storage memory 103 and the intra prediction result obtained in S503 (S504) and DCT section 145 performs a DCT operation on the differential information (S505).

Next, quantizing section 146 performs an quantization operation with respect to the data output by DCT section 145 (S506) and entropy encoding section 147 performs entropy encoding with respect to the data output by quantizing section 146 (S507), and the encoding result is temporarily stored as data of 1 MB of transcoded image 235b in a storage memory (not shown in the drawings) of transcoded stream combining section 152. In addition, the data that is output by quantizing section 146 is input to entropy encoding section 147 and the inverse quantization process is executed in encoder-side inverse quantizing section 148 (S508). Encoder-side inverse DCT section 149 performs an inverse DCT operation with respect to the data output by encoder-side inverse quantizing section 148 (S509) and local decoded image generating section 150 collects the decoded data of a unit of MB as one image data (S510). This data is used as the peripheral information in the intra prediction of S503 described above.

When the process step of S503 to S510 ends with respect to all MBs of the image, the loop process is skipped (R511). At that time, the transcoded image for each MB that is stored in transcoded stream combining section 152 is collected as one transcoded image and transcoded image 236b of the I picture is generated.

In addition, the process steps of the following S513 to S519 are repeated until a process of all of the macro blocks (MB) of decoded image 216 ends (R512).

First, encoder-side motion compensating section 142 acquires decoded image 216 of the time T6 from image storage memory 103, acquires the reference image from encoder-side reference image memory 151, and generates the prediction image based on the motion compensation for each MB (S513). However, a method of calculating the motion compensation sets a motion vector (MV) as zero and uses only the immediately previous local decoded image of the time T5 stored in encoder-side reference image memory 151 as the reference image as the time.

Differential information generating section 144 calculates the differential information between decoded image 216 input by image storage memory 103 and the prediction result by the motion compensation where the motion vector (MV) is set as the zero and only the reference image (decoded image 215) of the immediately previous reference image (decoded image 215) of the time T5 is used as the time (S514).

Next, DCT section 145 performs the DCT operation with respect to the differential information (S515), quantizing section 146 performs a quantization operation with respect to the data output by DCT section 145 (S516), and entropy encoding section 147 performs the entropy encoding with respect to the data output by quantizing section 146 (S517) and temporarily stores the encoding result as the data of 1 MB of transcoded image 236a in a storage memory (not shown in the drawings) of transcoded stream combining section 152. Finally, transcoded stream combining section 152 collects the transcoded images of the P picture stored in a unit of MB to generate transcoded image 236a (P picture), collects the transcoded image of the I picture stored in a unit of MB to generate transcoded image 236b, combines transcoded images 236a and 236b as one image, and generates image 236 (S519).

The combining base is transcoded image 236a of the P picture and transcoded image 236b of the I picture is stored in an area that is not used in the normal decode, which exists in a user-defined extension area defined by the H.264. Combined image 236 is stored in storage medium 102.

(3) With Respect to the Forward Reproduction (Decode):

Next, the forward reproduction of transcoded stream 221 that is stored in storage medium 102 will be described.

<Forward Reproduction of Transcoded Image 231 of the I Picture>

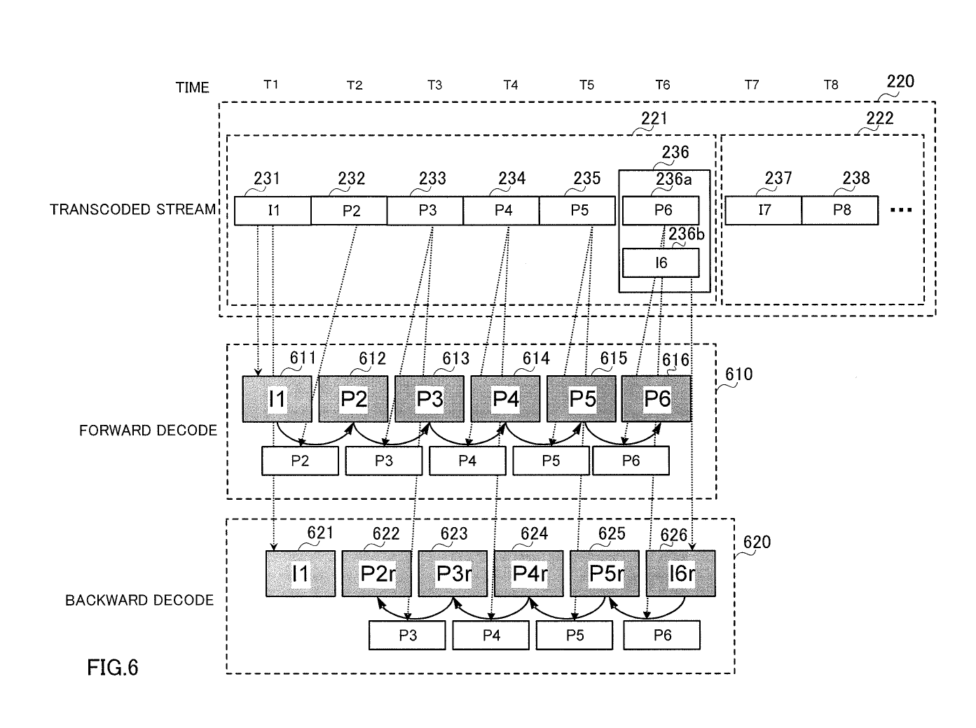

FIG. 6 is a diagram showing an example of the transcoded stream. Hereinafter, the forward reproduction (decode) of transcoded image 231 will be described using FIGS. 1, 3, and 6.

To decode device 120, transcoded image 231 of the I picture of the time T1 is input from storage medium 102 (S301). Entropy decoding section 121 performs entropy decoding on transcoded image 231 (S302). A process step from the following S304 to S312 is repeated until a process of all macro blocks (MB) of image 231 ends (R303).

Next, decoder-side inverse quantizing section 122 executes an inverse quantizing process on the entropy decoded data in a unit of MB (S304) and decoder-side inverse DCT section 123 executes the inverse DCT process on the inversely quantized data to generate differential information of the image data in a unit of MB (S305).

Decoder-side prediction method determining section 124 analyzes information of the image using the generated differential information and determines whether motion compensation is used in a unit of MB (B306). When the intra prediction is not used and the motion compensation is used, the process proceeds to S307 and when the intra prediction is used, the process proceeds to S308. In this case, since image 231 is the I picture, the process proceeds to S308 in all MBs. In addition, in decoder-side intra predicting section 125, the intra prediction is performed using the already decoded MB information fed back from decoded image generating section 128 as the peripheral information and the decoding is performed (S308).

The decoded image is temporarily stored in decoded image generating section 128 until the decoding is completed on all MBs in the image. The image that is temporarily stored in decoded image generating section 128 is used as peripheral information of the MBs to be decoded, in the process of S308 as described above (S312). After the process step from S304 to S312 ends with respect to all MBs of the image and decoded image 611 is generated, and then a loop process is skipped (R313). Finally, decoded image 611 that is generated by decoded image generating section 128 is stored in decoder-side reference image storage memory 129 (S314) and is transmitted to image storage memory 103 (S315). The image that is transmitted to image storage memory 103 is output to monitoring monitor 112 through image combining section 104 and is reproduced and displayed.

<Forward Reproduction of Transcoded Image 232 of the P Picture>

Next, the forward reproduction (decode) of transcoded image 202 will be described.

To decode device 120, transcoded image 232 of the P picture of the time T2 is input from storage medium 102 (S301). Entropy decoding section 121 performs entropy decoding with respect to transcoded image 232 (S302). A process step from the following S304 to S312 is repeated until a process of all macro blocks (MB) of image 232 ends (R303).

Next, decoder-side inverse quantizing section 122 executes an inverse quantizing process with respect to the entropy decoded data in a unit of MB (S304) and decoder-side inverse DCT section 123 executes the inverse DCT process with respect to the inversely quantized data to generate differential information of the image data in a unit of MB (S305).

Decoder-side prediction method determining section 124 analyzes information of the image using the generated differential information and determines whether motion compensation is used in a unit of MB (B306). When the intra prediction is not used and the motion compensation is used, the process proceeds to S307 and when the intra prediction is used, the process proceeds to S308. In this case, since entire image 232 is the P picture generated using the motion compensation prediction, the process proceeds to S307 in all MBs. In addition, decoder-side motion compensating section 126 processes the motion compensation data in a unit of MB and acquires the differential information of the image (S307).

In addition, code inverting section 127 determines a current decode direction (B309). The decode direction is a forward direction when the decode order follows time order and is a backward direction when the decode order follows inverse order of the time order. When the temporally forward decoding is performed, the process proceeds to S310. When the temporally backward decoding is performed, the process proceeds to S311.

With respect to the transcoded image 232, after decoding transcoded image 231 of the I picture of the time T1, transcoded image 232 of the P picture of the time T2 is decoded. Therefore, the forward decoding is performed and the process proceeds to S310. Since the forward decoding is performed, the differential information that is obtained by motion compensating section 126 is used in code inverting section 127 without inverting the code, a motion compensation process is executed using the decoded image stored in decoder-side reference image storage memory 129 as the reference image, and the decoding is performed (S310).

The decoded image is temporarily stored in decoded image generating section 128 until the decoding is completed with respect to all MBs of the image. The image that is temporarily stored in decoded image generating section 128 is used as peripheral information of the MBs to be decoded, in the process of S308 as described above (S312). After the process step from S304 to S312 ends with respect to all MBs of the image and decoded image 612 is generated, a loop process is skipped (R313). Finally, decoded image 612 that is generated by decoded image generating section 128 is stored in decoder-side reference image storage memory 129 (S314) and is transmitted to image storage memory 103 (S315).

The course of decoding transcoded image 232 of the P picture of the time T2 and generating decoded image 612 of the P picture is described above. However, the same process is executed with respect to transcoded images 233 to 235 of the P pictures of the following times T3 to T5 and forward decoded images 613 to 615 are obtained.

<Forward Reproduction of Transcoded Image 236 of the Back End of the GOP>

Next, the forward reproduction (decode) of transcoded image 236 of the back end of the GOP will be described.

To decode device 120, transcoded image 236 of the time T6 is input from storage medium 102 (S301). Entropy decoding section 121 performs entropy decoding with respect to transcoded image 236 (S302). A process step from the following S304 to S312 is repeated until a process of all macro blocks (MB) of transcoded image 236 ends (R303). In addition, the decode object in the forward decoding is only transcoded image 236a and transcoded image 236b that is stored in the user-defined extension area is discarded at that time.

First, decode device 120 executes the inverse quantization process with respect to the entropy decoded data in a unit of MB by decoder-side inverse quantizing section 122 (S304) and executes the inverse DCT process with respect to the inversely quantized data by decoder-side inverse DCT section 123 to generate the differential information of the image data in a unit of MB (S305).

Decoder-side prediction method determining section 124 analyzes image information with the generated differential information and determines whether motion compensation is used in a unit of MB (B306). When the intra prediction is not used and the motion compensation is used, the process proceeds to S307 and when the intra prediction is used, the process proceeds to S308. In this case, since image 236a is the P picture and the intra prediction is not used at the time of transcoding, the process proceeds to S307 in all MBs. In addition, decoder-side motion compensating section 126 processes the motion compensation data in a unit of MB and acquires the differential information of the image (S307).

First, code inverting section 127 determines the current decode direction (B309). Since transcoded image 236 is an image obtained by performing decoding with respect to transcoded image 235 of the P picture of the time T5, the forward decoding is performed and the process proceeds to S310. Since the forward decoding is performed, code inverting section 127 uses the differential information obtained by motion compensating section 126 without inverting the code, processes the motion compensation using the decoded image stored in decoder-side reference image image storage memory 129 as the reference image, and performs the decoding (S310).

The decoded image is temporarily stored in decoded image generating section 128 until the decoding is completed with respect to all MBs of the image. The image that is temporarily stored in decoded image generating section 128 is used as peripheral information of the MBs to be decoded, in the process of S308 as described above (S312). After the process step from S304 to S312 ends with respect to all MBs of the image and decoded image 616 is generated, a loop process is skipped (R313). Finally, decoded image 616 that is generated by decoded image generating section 128 is stored in decoder-side reference image storage memory 129 (S314) and is transmitted to image storage memory 103, and the entire forward decoding of transcoded stream 221 is finished. The image that is transmitted to image storage memory 103 is output to the monitoring monitor 112 through image combining section 104 (S315) and is reproduced and displayed.

(4) With Respect to the Backward Reproduction (Decode):

Next, the backward reproduction of transcoded stream 221 that is stored in storage medium 102 will be described. Since the backward reproduction (decode) is performed, according to the decode order of transcoded stream 221, transcoded image 236 of the time T6 is first decoded and transcoded image 231 of the time T1 is finally decoded.

Transcoded image 236 of the time T6 includes two pieces of information, i.e., transcoded image 236b of the intra prediction of decoded image 216 of the time T6 and transcoded image 236a using the motion compensation prediction which is the differential information between decoded images 215 and 216 of the times T5 and T6, and decoded image 626 of the time T6 and decoded image 625 of the time T5 are obtained by decoding the images in order of transcoded images 236b and 236a.

<Backward Reproduction of Transcoded Image 236 of the Back End of the GOP (first)>

To decode device 120, transcoded image 236 of the time T6 is input from storage medium 102 (S301). Entropy decoding section 121 performs entropy decoding with respect to transcoded image 236 (S302). A process step from the following S304 to S312 is repeated until a process of all macro blocks (MB) of image 236 ends (R303).

In addition, the first decode object of the backward reproduction (decode) is transcoded image 236b of the intra prediction that is stored in the user-defined extension area and transcoded image 236a using the motion compensation prediction that is used in the normal decoding is not used at that time.

First, decode device 120 executes the inverse quantization process with respect to the entropy decoded data in a unit of MB by decoder-side inverse quantizing section 122 (S304) and executes the inverse DCT process with respect to the inversely quantized data by decoder-side inverse DCT section 123 to generate the differential information of the image data in a unit of MB (S305).

Decoder-side prediction method determining section 124 analyzes image information with the generated differential information and determines whether motion compensation is used in a unit of MB (B306). When the intra prediction is not used and the motion compensation is used, the process proceeds to S307 and when the intra prediction is used, the process proceeds to S308. In this case, since image 236b is the I picture using the intra prediction, the process proceeds to S308 in all MBs. In addition, decoder-side intra predicting section 125 performs the intra prediction using the already decoded MB information fed back from decoded image generating section 128 as the peripheral information and performs the decoding (S308).

The decoded image is temporarily stored in decoded image generating section 128 until the decoding is completed with respect to all MBs of the image. The image that is temporarily stored in decoded image generating section 128 is used as peripheral information of the MBs to be decoded, in the process of S308 as described above (S312). After the process step from S304 to S312 ends with respect to all MBs of the image and decoded image 626 is generated, a loop process is skipped (R313). Finally, decoded image 626 that is generated by decoded image generating section 128 is stored in decoder-side reference image storage memory 129 (S314) and is transmitted to image storage memory 103. The image that is transmitted to image storage memory 103 is transmitted to image combining section 104. The image that is transmitted to image storage memory 103 is transmitted to image combining section 104, is output to monitoring monitor 120 (S315), and is reproduced and displayed.

<Backward Reproduction of Transcoded Image 236 of the Back End of the GOP (Second)>

To decode device 120, transcoded image 236 of the time T6 is input from storage medium 102 (S301). Entropy decoding section 121 performs entropy decoding with respect to transcoded image 236 (S302). A process step from the following S304 to S312 is repeated until a process of all macro blocks (MB) of image 236 ends (R303).

In addition, the second decode object of the backward decoding is transcoded image 236a using the motion compensation prediction. Since transcoded image 236b of the intra prediction that is stored in the user-defined extension area is already decoded as described above, the transcoded image is not used.

First, decode device 120 executes the inverse quantization process with respect to the entropy decoded data in a unit of MB by decoder-side inverse quantizing section 122 (S304) and executes the inverse DCT process with respect to the inversely quantized data by decoder-side inverse DCT section 123 to generate the differential information of the image data in a unit of MB (S305).

Decoder-side prediction method determining section 124 analyzes image information with the generated differential information and determines whether motion compensation is used in a unit of MB (B306). When the intra prediction is not used and the motion compensation is used, the process proceeds to S307 and when the intra prediction is used, the process proceeds to S308. In this case, since image 236a is the P picture using only the motion compensation prediction, the process proceeds to S307 in all MBs. In addition, decoder-side motion compensating section 126 processes the motion compensation data in a unit of MB and acquires the differential information of the image (S307). In this case, the image to calculate the difference is decoded image 626 of transcode image 236b that is stored in decoder-side reference image storage memory 129.

Next, code inverting section 127 determines the current decode direction (B309). When the temporally forward decoding is performed, the process proceeds to S310 and when the temporally backward decoding is performed, the process proceeds to S311. With respect to transcoded image 236a, decoding of transcoded image 236b of the I picture of the time T6 is performed, and decoded image 625 of the time T5 is generated. Therefore, the backward decoding is performed and the process proceeds to S311. Since the backward decoding is performed, in code inverting section 127, positive and negative codes of the differential information obtained by motion compensating section 126 are inverted and the differential information is used, the process of the motion compensation is executed using the decoded image stored in decoder-side reference image storage memory 129 as the reference image, and the decoding is performed (S311).

The decoded image is temporarily stored in decoded image generating section 128 until the decoding is completed with respect to all MBs of the image (S312). After the process step from S304 to S312 ends with respect to all MBs of the image and decoded image 625 is generated, a loop process is skipped (R313). Finally, decoded image 625 that is generated by decoded image generating section 128 is stored in decoder-side reference image storage memory 129 (S314) and is transmitted to image storage memory 103. The image that is transmitted to image storage memory 103 is output to monitoring monitor 112 through image combining section 104 (S315) and is reproduced and displayed.

<Backward Reproduction of Transcoded Image 235 of the P Picture>

Next, to decode device 120, transcoded image 235 of the time T5 is input from storage medium 102 (S301). Entropy decoding section 121 performs entropy decoding with respect to transcoded image 235 (S302). A process step from the following S304 to S312 is repeated until a process of all macro blocks (MB) of image 235 ends (R303).

First, decode device 120 executes the inverse quantization process with respect to the entropy decoded data in a unit of MB by decoder-side inverse quantizing section 122 (S304) and executes the inverse DCT process with respect to the inversely quantized data by decoder-side inverse DCT section 123 to generate the differential information of the image data in a unit of MB (S305).

Decoder-side prediction method determining section 124 analyzes image information with the generated differential information and determines whether motion compensation is used in a unit of MB (B306). When the intra prediction is not used and the motion compensation is used, the process proceeds to S307 and when the intra prediction is used, the process proceeds to S308. In this case, since image 235 is the P picture using only the motion compensation prediction, the process proceeds to S307 in all MBs. In addition, decoder-side motion compensating section 126 executes the process of the motion compensation in a unit of MB and acquires the differential information of the image (S307). In this case, the image to calculate the difference is decoded image 626 of transcoded image 235 that is stored in decoder-side reference image storage memory 129.

Next, code inverting section 127 determines the current decode direction (B309). With respect to transcoded image 235, the decoding of transcoded image 236a of the P picture of the time T6 is performed, and decoded image 624 of the time T4 is generated. Therefore, the backward decoding is performed and the process proceeds to S311. Since the backward decoding is performed, in code inverting section 127, positive and negative codes of the differential information obtained by motion compensating section 126 are inverted and the differential information is used, the process of the motion compensation is executed using the decoded image stored in decoder-side reference image storage memory 129 as the reference image, and the decoding of the data with respect to MB is performed (S311).

The decoded image is temporarily stored in decoded image generating section 128 until the decoding is completed with respect to all MBs of the image (S312). After the process step from S304 to S312 ends with respect to all MBs of the image and decoded image 625 is generated, a loop process is skipped (R313). Finally, decoded image 624 that is generated by decoded image generating section 128 is stored in decoder-side reference image storage memory 129 (S314) and is transmitted to image storage memory 103 (S315). The image that is transmitted to image storage memory 103 is transmitted to image combining section 104.

The course of decoding transcoded image 235 of the P picture of the time T5 and generating decoded image 624 of the P picture of the time T4 is described above. However, by executing the same process with respect to following transcoded image 234 of the P picture of the time T4 and transcoded image 233 of the time T3, decoded images 623 and 622 can be obtained. Decoded image 622 of the P picture of the time T2 is not used in the backward decoding.

<Backward Reproduction of Transcoded Image 231 of the I Picture>

The generation order of decoded image 621 is the same as that of the forward decoding of transcoded image 231. That is, decoded image 621 is equal to decoded image 611.

The forward decoding and the backward decoding are described separately in the above description. For example, when decoding of decoded image 614 of the time T4 by the forward decoding is considered as a reference, if the forward decoding is performed using transcoded image 235 which is the differential information between the times T4 and T5, decoded image 615 of the time T5 is obtained. If the backward decoding is performed using transcoded image 234 which is the differential information between the times T3 and T4, decoded image 615 of the time T3 is obtained. That is, an image temporally before or after one image can be decoded by only one decode process, with respect to the decoded image at the certain time, regardless of the current GOP structure.

### [3] Effect of the Embodiment

As described above, according to this embodiment, when encoder-side intra predicting section 141 transcodes the decoded images of the front end and the back end of the GOP of the image stream and encoder-side motion compensating section 142 transcodes the decoded image other than the front end of the GOP of the image stream by setting the motion vector as 0 and using only the immediately previous reference image to perform the backward reproduction (decode) from a certain time, in the case of the GOP structure including the P picture using the time correlation, desired backward reproduction (decode) can be performed by setting one immediately previous image as the reference image and performing only one decoding using the corresponding image, without performing decoding corresponding to the number of structures of the GOP. That is, regardless of whether the decode reproduction direction is switched to the forward direction or the backward direction at the certain time, reproduction of a desired direction can be realized by one decoding without affecting a decode operation of the forward direction.

### [4] Other Embodiment

In this embodiment, the example of the case where the number of input streams is one is described. Of course, the present invention can be similarly applied to the case where streams of other arbitrary numbers are input. In addition, the example of the GOP structure that does not include the B picture in input stream 200 is described. However, the present invention can be similarly applied to the general GOP structure that includes the B picture. In addition, the example of the case where the transcoded stream generation start position is set as decoded image 211 of the I picture of the time T1 is described. However, the present invention can be similarly applied to other arbitrary start times. In addition, the example of the case where the number of the GOP structures of the transcoded stream is 6 is described above. However, the present invention can be similarly applied to the case of the number of other arbitrary GOP structures.

The present invention is not limited to the embodiment described above and the changes or applications can be made for some parts of the structure and the operation by those skilled in the art, on the basis of the description of the specification and the known technologies.

The present invention can be applicable to a codec that has extension area such as mpeg2, mpeg4, H.264, and so on.

### INDUSTRIAL APPLICABILITY

In the image converting apparatus, the image reproducing apparatus, and the image converting method according to the present invention, when the backward reproduction is performed, all of the reference images do not need to be decoded in the forward direction in advance, the decoding can be performed in the backward direction, and the high-speed reproduction (decode) can be performed in both the forward direction and the backward direction. Therefore, the present invention can be applied to an image reproducing apparatus that performs special reproduction such as rewind reproduction.

### REFERENCE SIGNS LIST

100 image reproducing apparatus
102 storage medium
103 image storage memory
104 image combining section
120 decode device
121 entropy decoding section
122 decoder-side inverse quantizing section
123 decoder-side inverse DCT section
124 decoder-side prediction method determining section
125 decoder-side intra predicting section
126 decoder-side motion compensating section
127 code inverting section
128 decoded image generating section
129 decoder-side reference image storage memory
140 transcode device
141 encoder-side intra predicting section
142 encoder-side motion compensating section
143 encoder-side prediction method determining section
144 differential information generating section
145 DCT section
146 quantizing section
147 entropy encoding section
148 encoder-side inverse quantizing section
149 encoder-side inverse DCT section
150 local decoded image generating section
151 encoder-side reference image storage memory
152 transcoded stream combining section

1. An image conversion apparatus which transcodes a digitally compressed image stream, comprising:
an intra predictor configured to convert a decoded image of the image stream into an intra prediction image; and
a motion compensated predictor configured to convert a decoded image of the image stream into a motion compensated prediction image, wherein:
the intra predictor transcodes first and final decoded images of a GOP (Group of Pictures) of the image stream, and
the motion compensated predictor transcodes all decoded images except the first decoded image of the GOP of the image stream by setting a motion vector to zero and referring to only an immediately preceding decoded image.

2. The image converting apparatus according to claim 1, wherein:
the digitally compressed image stream is transcoded according to a codec that has an extension area;
a motion compensation prediction image obtained by transcoding the decoded image of a back end of the GOP of the image stream is stored in a decode area of the codec; and
the intra prediction image and the motion compensated prediction image which are obtained by transcoding the decode image other than that of the back end of the GOP of the image stream are stored in the extension area of the codec.

3. An image reproducing apparatus, comprising:
a decoder which generates a decode image of a digitally compressed image stream; and
the image converting apparatus according to claim 1 which transcodes the decode image, wherein:
when a forward reproduction is performed, transcoded images are sequentially decoded and reproduced by the decoder and the back end of the GOP is decoded and reproduced to produce a motion compensation prediction image, and
when a backward reproduction is performed, the back end of the GOP of the transcoded image is decoded and reproduced by the decode device using the intra prediction image.

4. The image converting apparatus according to claim 1, wherein:
a number of images of the GOP of the digitally compressed image stream is different from a number of images of the GOP of the transcoded stream.

5. An image converting method which transcodes a digitally compressed image stream, comprising:
converting a decoded image of the image stream into an intra prediction image; and
converting a decoded image of the image stream into a motion compensated prediction image, wherein:
converting a decoded image of the image stream into an intra prediction image transcodes first and final decoded images of a GOP (Group of Pictures) of the image stream; and
converting a decoded image of the image stream into a motion compensated prediction image transcodes all decoded images except the first decoded image of the GOP of the image stream by setting a motion vector to zero and referring to only an immediately preceding decoded image.
